(19) United States
(12) Patent Application Publication
(10) Pub. No.: US 2016/0221853 A1
(43) Pub. Date: Aug. 4, 2016

(54) WATER CLARIFICATION AND SLUDGE DEWATERING SYSTEMS

(71) Applicant: Steven Leslie Cort, Cary, NC (US)

(72) Inventor: Steven Leslie Cort, Cary, NC (US)

(21) Appl. No.: 14/612,798

(22) Filed: Feb. 3, 2015

(51) Int. Cl. C02F 11/12

(52) U.S. Cl. CPC C02F 11/12; C02F 11/121; C02F 2303/06

(57) ABSTRACT

The present invention relates to combining water clarification with sludge dewatering into one unit and to other methods to combine water flocculation and water screening to treat water by also using biocarrier materials made from waste materials.

### CROSS-REFERENCE TO RELATED APPLICATION

Provisional application No. 61/935,637 filed on Feb. 4, 2014.

### FIELD OF THE INVENTION

The present invention relates to the process of treating of water specifically to the use of magnetic material to enhance the clarification of water and to specific designs and methods to combine magnetic ballast clarification with sludge dewatering.

### BACKGROUND OF THE INVENTION

Clarification, that is the removal of suspended solids from water, is an important part of water treatment. There are many methods practiced for separating suspended solids from water such as gravity clarification with or without the use of inclined plates, ballast clarification including Actiflo (sand ballast clarification), MBC (magnetic ballast clarification), Comag (magnetic ballast clarification), Biomag (magnetic biological treatment), Densadeg (high density gravity clarification), filtration including membranes, screens, and cartridges, and DAF (dissolved air flotation).

Clarification is usually reserved for removing low concentrations of suspended solids from water, normally in the hundreds of parts per million to produce a waste slurry that is in the thousands of parts per million.

Unless recycled, most low value wastes are disposed in landfills in a solid form. Therefore, the waste streams from most water clarification technologies that go to landfill require a separate dewatering step to eliminate the drainage of free water from sludge as shown by passage of the paint filter drip test. This dewatering step is accomplished by technologies like filter presses, screw presses, centrifuges, fan presses, volute ring presses, and others.

Heretofore, clarification and dewatering equipment were designed, built, sold, and installed separately, which took up additional space and created physical and electrical interface problems. These two types of equipment, clarification and dewatering, have never been integrated into one unit where dewatering equipment is positioned on top of the clarification equipment so that filtrate from the dewatering equipment flows by gravity into the clarification equipment. This arrangement reduces piping requirements and significantly reduces the total footprint and total cost. This patent application proposes such a novel and new layout plan for combining water clarification and sludge dewatering into one unit.

FIG. 2 in Cort U.S. Pat. No. 7,820,053 shows the combination of flocculation and gravity settling in one tank. Settled solids in the gravity settling section of the tank flow by gravity counter-currently into the flocculation section of the tank against the flow of water. Therefore, at high flow rates the flow of water from the flocculation section of the tank is too great to let the settled solids leave the gravity settling section of the tank. This causes a buildup of solids in the gravity settling section of the tank and eventually causing the discharge of solids from the system. This patent application proposes a new flow path of water to eliminate this problem.

Cort U.S. Pat. No. 7,691,269 describes converting gravity clarifiers into biological reactors by replacing the clarification function with a high rate clarification system inside the clarifier. The high rate clarification system is defined to have a surface overflow rate of greater than five gallons per minute per square foot of surface area. This patent application clarifies the definition of high rate clarification to be any system that removes solids from water regardless of the surface overflow rate measured in gallons per minute per square foot of surface area. Specifically this includes any type of filtration or solids separation technology, but more specifically, includes Continuous Deflective Separation (CDS) technology. Biological reactor, as defined in this patent application, includes any system that uses bacteria to treat water in any way, which also specifically includes but not limited to a biological contact tank and a Moving Bed Biological Reactor (MBBR).

A MBBR contains biocarriers that improve the biological treatment process. This patent application describes how the performance of a screen separator, inserted inside a single stage treatment (aerobic) MBBR (FIG. 3) or in a two stage (aerobic and anaerobic) MBBR (FIG. 4) can be improved with the use of a flocculating polymer.

Based on work by Dr. Al Sun of CDM, active biological solids can adsorb dissolved BOD from CSO (Combined Sewer Overflow) and SSO (Sanitary Sewer Overflow). Both BioActiflo and BioMag are based on this work and use Mixed Liquor Suspended Solids (MLSS) in a biological contact tank followed by high rate clarification in a separate standalone system. BioActiflo uses a sand ballast clarifier and BioMag uses a lamella clarifier for final solids clarification. Both BioActiflo and BioMag take up large amounts of additional space for their biological contact tank and clarification and have high capital costs. This patent application claims how these costs can be greatly reduced with no increase in facility footprint if a high rate clarification system is installed inside a clarifier and the clarifier is modified to contain an amount of MLSS necessary to adsorb soluble BOD in a short period of time (less than 15 minutes) per the work by Dr. Sun.

Excess wet weather flows from storm events cause significant harm to the environment. This is especially true in CSO systems that combine sanitary wastes with storm water and also in sanitary systems that experience excessive inflow and infiltration (SSO). In both cases, large volumes of untreated water, containing quantities of hazardous solids, can flow into the environment. End of pipe treatment in Waste Water Treatment Plants (WWTPs) is the best and sometimes the only alternative to treat these untreated discharges from storm events but existing facilities are often limited in treatment capacity and often space is not available for expansions so it is important that the solution to the problem is cost effective and small in size.

Treatment of large flow stemming from sources such as discharge from storm water and CSO/SSO require efficient clarification technology to minimize the size of treatment systems to treat these high flows. Presently, gravity clarification is too slow and requires large areas of land for this type of treatment. Ballast clarification, while much smaller in size than gravity clarification, can be expensive and complicated to operate, and produces large quantities of waste for additional treatment if sand is used as the ballast material. Membrane technology is expensive and still has fouling issues due to organics found in these types of wastewater.

The most effective storm water treatment systems are therefore small in size, can effectively remove suspended solids, have high treatment capacity, are non-fouling, simple to operate, startup rapidly, and can treat varying flow rates.

One method contained in this patent application that meets all of these design parameters combines flocculation using ballast material and screening devices to prevent the discharge of suspended solids. The combination of these two processes in one unit is novel and never been practiced before.

Screening is the simplest and most cost effective way to treat high flow rates associated with storm events. However screens can foul causing high pressure drops and cleaning problems and are not effective in removing fine suspended solids (less than 100 micron). When the screen opening size is reduced in order to remove fine suspended solids, fouling becomes a bigger problem. This patent application describes in detail methods to prevent screen fouling and to improve their ability to remove fine suspended solids from water.

Combining the high rate capacity of screens, specifically non-clogging screens, with flocculation using flocculating polymers and ballast material having sizes greater than the screen openings is proposed in this patent application.

What makes this approach so effective is that screening of solids is highly effective but requires that the openings in the screen are smaller than the solids you wish to screen. However, most water pollution is contained in the small, suspended solids of micron size and smaller and to remove these small solids require fine screens that can clog and cause high pressure drop. Attaching small, suspended solids to larger ballast material with a flocculating polymer will solve this problem because the large ballast will not pass through the smaller screen openings. The advantages of this new and novel approach to enhance the performance of screens to treat wastewater are described in the patent application.

Large flows of water stemming from storm events are costly to treat. It is not uncommon for these flow rates to exceed tens of thousands of gallons per minute and even hundreds of thousands of gallons per minute. Presently, one common practice to treat storm water is to use screens to remove grit and floatables. However screens cannot effectively remove fine suspended solids below 100 microns in size and therefore are not effective in removing much of the water pollution. Therefore, it is important to combine first the separation of grit and settable solids, and second using flocculation with flocculating polymers in combination with or without the use of ballast material to remove fine suspended solids by screening in one structure. This method of treatment to combine grit and floatables separation in the same unit with fine suspended solids separation by clarification using flocculating polymers and ballast material as presented in this patent application is novel and new.

Adding a biocarrier to an existing activated sludge treatment is an easy retrofit and will enhance the biological treatment process by increasing the bacteria concentration and types of bacteria used to treat water. The biocarrier is usually made from virgin thermoplastics with a gravity of close to 1.0 g/cc (grams per cubic centimeter), which is expensive and constitutes a major portion of the cost of a MBBR retrofit. The complicated designs of these biocarriers to increase their surface area require that they be extruded under high pressure so they can be mass-produced. The extruders contain close tolerance pistons and therefore require virgin plastics that contain no contaminants that could damage the pistons. A better solution is to produce biocarriers from waste thermoplastics such as polyethylene, polypropylene, polyvinylchloride, polyester, and nylon. However since these waste plastics often contain some contaminants, thermal extrusion is not recommended. Therefore this patent application describes not only the use of waste thermoplastics for biocarriers but also a better way to efficiently produce biocarriers from waste thermoplastics combined with various fillers to control the density of the biocarriers and to reduce cost.

Beyond increasing biological treatment capacity and efficiency, biocarriers can prevent fine suspended solids from passing through a screen. If fine suspended solids are attached to the biocarrier with a flocculating polymer, which is much larger than the screen opening, then the combined biocarrier/suspended solid particle is too large to pass through the smaller screen opening. This approach to improve the performance of a screen with a biocarrier and a flocculating polymer in one tank is new and novel and more fully described in this patent application.

### BRIEF SUMMARY OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer. Furthermore, it is an objective of this invention to provide such a system and method, which eliminates problems associated with slow settling rates of biological flocs in a secondary clarifier.

Furthermore, it is an objective of this invention to provide such a system and method, which increases the capacity of any biological treatment system.

Furthermore, it is an objective of this invention to provide such a system and method, which effectively removes contaminants from all types of wastewater.

Furthermore, it is an objective of this invention to provide such a system and method, which is novel and cost effective.

Furthermore, it is an objective of this invention to provide such a system and method, which is reliable and simple to operate.

Furthermore, it an objective of this invention to provide such a system and method which is robust and with few operating problems.

Furthermore, it is an objective of this invention to prevent fouling problems often associated with membrane systems or stainless steel wool magnetic collectors.

Furthermore, it is an objective of this invention to provide such a system and method, which enhances removal of contaminants from wastewater, especially nutrients like phosphorus and nitrogen and toxic components like heavy metals.

Furthermore, it is an objective of this invention to provide such a system and method, which is effective in removing high concentration of suspended solids from wastewater.

Furthermore, it is an objective of this invention to decrease the amount of waste generated by increasing the concentration of solids in the final waste stream.

Furthermore, it is an objective of this invention to provide such a system and method, which can increase the concentration of biosolids in a biological treatment system to increase its treatment capacity.

Furthermore, it is an objective of this invention to provide such a system and method, which can increase the wastewater flow and/or loading to increase the capacity of a gravity clarifier.

Furthermore, it is an objective of this invention to provide such a system and method, which reduces the typical footprint of a high rate clarification system.

Furthermore, it is an objective of this invention to provide such a system and method, which reduces capital and operating costs and land requirements.

Furthermore, it is an objective of this invention to retrofit existing water treatment systems to enhance performance and to reduce costs without increasing the footprint of the treatment system.

Furthermore, it is an objective of this invention to provide such a system and method, which will provide a high quality secondary effluent.

Furthermore, it is an objective of this invention to reduce the cost of biocarriers by manufacturing them out of waste thermoplastics.

Furthermore, it is an objective of this invention to provide an efficient way to manufacture biocarriers out of waste thermoplastics.

Furthermore, it is an objective of this invention to provide such a system and method, which improves the treatment efficiency of treating large flows associated with storm events.

Furthermore, it is an objective of this invention to provide such a system and method, which meets local, state and federal regulations for water and wastewater.

The subject invention, however, in other embodiments, need not achieve all these objectives and the claims hereof should not be limited to structures or methods capable of achieving these objectives.

Dewatering solids is in an important part of most water clarification systems. The solids concentration of the slurries produced from most water clarification systems ranges from 0.1% to 5%. This still leaves a large amount of water that increases disposal costs. Dewatering technologies can increase the solids concentration to over 30 wt. % thereby reducing disposal costs and allowing waste solids to be disposed in landfills.

Such dewatering technologies include but are not limited to centrifuges, fan presses, volute ring presses, belt presses, and filter presses. With the exception of a filter press, all of these dewatering technologies operate continually and are well adapted to integrate with continuous clarification technologies.

However, heretofore, clarification equipment and dewatering equipment (sludge press) have been built, sold, and installed separately. This increases footprint, causes electrical and physical interface problems, and increases cost. The novel approach of this patent is to combine clarification equipment with dewatering equipment into one system contained in one unit where a slurry of waste solids flows from the clarification part of the system either by gravity or pumped into the sludge dewatering part of the system and the filtrate from the sludge dewatering flows back by gravity back into the clarification part of the system. The clarification part of the system includes but is not limited to any technology that uses ballast seed material to improve clarification or any other clarification technologies such as DAF or filtration. The dewatering part of the system can include any continuous equipment that reduces the water content of a slurry (sludge press), which includes but is not limited to centrifuges, fan presses, screw presses, volute ring presses, and belt presses.

Clarifiers are often limited by the amount of solids they can remove from water. For example, a gravity clarifier cannot effectively treat water that contains more than 4000 ppm of solids, especially if these solids have a low density. A ballast clarifier is limited by the amount of solids it can process because the amount of solids in the water increases the size of the ballast cleaning system and hinders the settling of solids. In most applications, when the suspended solids level in wastewater is low, the wastewater is first clarified to remove suspended solids and the waste slurry from the clarifier is then pumped to the sludge press for dewatering. The sludge press discharges a solid cake and a filtrate from the sludge press flows by gravity back to the clarifier.

When the solids concentration of the wastewater is too high for clarification first, the flow through the combined system is reversed. First, wastewater flows into the sludge press that discharges a solid cake and a filtrate from the sludge press flows by gravity to the clarifier. The clarifier produces clear effluent for discharge and concentrated waste slurry from the clarifier is pumped back to the sludge press for dewatering.

In summary, what is novel about this patent application is that two unit processes (clarification and sludge dewatering) are contained in one unit and the flow of filtrate water from the sludge dewatering process flows by gravity into the clarification process. Therefore, suspended solids can be removed from wastewater to produce clarified water and dewatered sludge all in one unit. Also, depending on the level of solids in the wastewater the order of treatment can be easily reversed without rearranging the equipment so this combination, in the ways described in this patent application, can treat a wide range of waste water solids concentrations from a few parts per million to a few weight percent. The layout of combined clarification and sludge dewatering is shown in FIGS. 1a and 1b.

FIG. 2 in Cort U.S. Pat. No. 7,820,053 shows the combination of flocculation and gravity settling in one tank. Wastewater to be clarified enters the flocculator and after a flocculating polymer is added, the flocculated solids flow out the bottom of the flocculator into the gravity settler. Clear water flowed out the top of the gravity settler and settled solids would flow by gravity back into the flocculator where they could be removed. This layout caused a problem because as water flowed out of the flocculator, solids were trying to flow counter currently back into the flocculator. Under high flow rates, flocculated solids could not flow back into the flocculator and would build up in the gravity settler eventually overflowing out of the system. This patent application corrects this previous shortcoming. A separate flow path has been added to eliminate this bottleneck. Now water that flows into the flocculator flows past the bottom of the gravity settler and entrains settled solids out of the gravity settler into the flocculator. After these solids are flocculated they then flow out the top of the flocculator and down through a separate pathway leading into the gravity settler. This novel and new arrangement improves upon previous designs. This enhancement is shown in FIG. 2 of this patent application.

Biological treatment is an effective method used to remove dissolved organics contained in water. A new proven and cost effective biological treatment process is the Moving Bed Biological Reactor (MBBR). It involves adding a biocarrier to a suspended biological growth system like the commonly used Activated Sludge (AS) system. The biocarrier provides a large surface area for the growth of bacteria biofilm. This biofilm increases the concentration of bacteria in the treatment system, which increases its treatment capacity. It also reduces the amount of suspended solids leaving the treatment system. An AS system may have a suspended solids level in its effluent of between 1000 and 5000 ppm while a comparable MBBR system may have a suspended solids level in its effluent of between 200-400 ppm. This makes the MBBR an ideal system that increases biological treatment capacity and reduces the amount of solids flowing to final clarification. Therefore installing a high rate clarification system either inside or after a MBBR system is an ideal combination and has not been practiced before and is now claimed in this patent application.

The biocarrier used in a MBBR can also be used to improve the performance of a screen separator. FIG. 3 shows screen flocculator installed inside a MBBR. The effluent from a MBBR contains a combination of suspended solids (bacteria and TSS), and biocarrier (when no retaining screens are applied). To prevent fine suspended solids passing through a screen device, a polymer is added to attach the suspended solids to the biocarrier. Normally the biocarrier is less than 3 millimeters in length and diameter so it will not pass through the small screen openings. Reducing the size of the biocarrier also increases the surface area needed for attachment of suspended solids.

With the lowering of nutrient limits becoming more common, it has become necessary to improve the performance of AS systems. This sometimes involves a technology called Biological Nutrient Removal (BNR), which involves various biological treatments at different oxygen levels to achieve nitrification and denitrification. Nitrification involves converting ammonia and other nitrogen compounds to nitrates and nitrites in the presence of oxygen (aerobic) and denitrification involves converting nitrates and nitrites to nitrogen gas in the absence of oxygen.

It is known in the art that nitrification and denitrification can be accomplished in one tank by controlling the level of oxygen and the type of bacteria in different zones of the tank. It is also known that nitrification and denitrification can be accomplished in separate MBBR tanks. However, if the MBBR technology can be applied for nitrification and denitrification in one tank, significant savings in cost and space would be realized. This requires that the biocarrier be segregated between various zones containing different levels of oxygen. One way to accomplish this segregation is by installing screens. However, as described in this patent application, rather than using screens, which can become fouled, segregation of biocarriers in a MBBR is best accomplished by changing the specific gravity of the biocarriers so some will have a density less than 1.0 g/cc and will rise to the top of the tank and some will have a density greater than 1.0 g/cc and will settle to the bottom of the tank. This patent application shows a method to keep the two biocarriers substantially segregated by controlling the density of the biocarrier and applying proper mixing methods.

The top of the tank is aerobic and is mixed by the addition of air bubbles. The bottom of the tank is anaerobic and is mixed with a stirrer to prevent the entrainment of air.

The density of the biocarriers can be adjusted by the type of plastic used or by the addition of light fillers to reduce the density of the biocarrier so it will reside in the top of the tank which is aerobic or by the addition of heavy fillers to increase the density of the biocarrier so it will reside in the bottom of the tank which is anaerobic.

This segregation of biocarriers by their density and mixing methods is new and novel and shown in FIG. 4.

Special care must be taken when using screens to remove suspended solids from water and if not properly designed can clog and not be able to effectively remove suspended solids from water. Also, screens are usually not effective in removing small particles less than 100 microns. One solution to this problem, which is known in the art, is the use of flocculating polymers to cause small particles to floc together into larger particles that should not pass through a screen. However, these flocs can be fragile and break up so they can still pass through a screen. This limitation is well known by those experienced in the art.

In large flow applications, screens have the advantage that they can process a high flow rate but for screens to be effective, this patent application describes ways to overcome these limitations.

First, it is preferred that the screen should have characteristics that deflect the solids away from the openings in the screen. This preferred technology, Continuous Deflective Separation (CDS), causes water to flow parallel to the surface of the screen rather than perpendicular to the surface of the screen. This flow path deflects the solids away from the specially designed screen openings. The CDS method is well known but requires the use of a flocculating polymer to effectively produce high clarity water. Use of a flocculating polymer by itself causes problems with floc breakup and flocculating polymers can foul the screen.

This patent application describes ways to overcome these problems by using flocculating polymers and ballast material to improve the performance of screen devices. While ballast material have been used to increase the speed of particle settling in water, heretofore, ballast materials have not been used to enhance the performance of screen devices.

When using ballast materials to enhance the performance of screen devices, fine suspended solids are attached to the ballast material (sized larger than the screen's openings) using a flocculating polymer. Therefore the large ballast floc that contains the attached fine suspended solids will not pass through the smaller screen openings. The concept of using a ballast material to improve the ability of a screen to remove fine suspended solids from water is shown in more detail in FIG. 5a where flocculation and screening are performed in one tank and a ballast material is used to prevent the passage of fine suspended solids through a screen. Water that contains fine suspended solids first is mixed with a flocculating polymer to form a large floc containing ballast material that will not pass through a selected sized screen opening. The mixing action causes the water to move in a circular motion so the solids that rise from the flocculation in the treatment tank will not easily clog the screen. As the floc rises to the surface of the treatment tank it will not pass through the small screen opening and only clarified water will pass through the screen. Ballast floc is withdrawn from the system, cleaned and returned for reuse.

FIG. 5b is an alternative to FIG. 5a and involves attaching suspended solids to a biocarrier to prevent the fine suspended solids from passing through a screen. In this case, the biocarrier and attached suspended solids are returned to the biological reactor.

An effective variation of this combined ballast flocculation and screen separation is to convert an existing clarifier to a biological reactor by placing screens at the point where water overflows the discharge weir. Water jets and aeration devices can be added to the clarifier to maintain the solids in suspension and to support biological treatment. This proposed layout is shown in FIG. 6. Biocarriers can also be added to the clarifier to promote biological treatment.

Water discharging from a clarifier normally discharges over a weir located around the perimeter of the clarifier. As the flow of water increases in the clarifier during wet weather events, biosolids will overflow the weir into the discharge trough. As this water and suspended solids flows through the discharge trough, a flocculating polymer is added to cause the biosolids to floc together.

The flocculated water then flows into a continuous screen separator that is mounted inside the clarifier. The flow of water moves in a circular motion across the surface the screen to prevent clogging. A mixer is mounted in the screen separator to maintain the circular flow of water across the screen to prevent clogging and to assure that the water flows in a downward direction back into the clarifier.

Clarified water passing through the screen is then discharged. The solids discharge back into the clarifier to maintain a high level of active biosolids to adsorb incoming soluble BOD.

Treatment of storm water involves removing grit and floatables and this is accomplished in either screen devices, collection chambers that settle grit and remove floatables, and vortex separators. However, none of these devices are effective in removing fine suspended solids from storm water. Systems that are effective in removing fine suspended solids usually employ the use of a flocculating polymer to cause fine suspended solids to floc together so they can be removed by gravity separation, ballast separation, or filtration. No one system is capable of removing grit, floatables, and fine suspended solids all in one unit. This patent application describes a new and novel system that can remove grit, floatables, and fine suspended solids in all one unit.

Storm water can either be just storm water or storm water combined with sanitary waste in CSO and SSO applications. Storm water that contains grit, floatables, and fine suspended solids first flows through a screen device that removes grit and floatables that are then contained in a collection chamber. The storm water that passes through the first screen now only contains fine suspended solids that flow into a flocculator screen device. In the flocculator screen device, a polymer is added to attach the fine suspended solids to the ballast contained therein. This prevents the passage of fine suspended solids and ballast because of its size through the openings of the second screen. The floc is removed from the flocculator screen device so the ballast can be cleaned and returned to the unit for reuse. This combined treatment system that removes grit, floatables and fine suspended solids in one unit is shown in FIGS. 7a and 7b.

In those applications that involve the use of a biocarrier, as an alternative to using ballast and a flocculating polymer to prevent passage of fine suspended solids through a screen, the biocarrier can be used to prevent the passage of fine suspended solids through a screen. The correct selection and use of a flocculating polymer can attach fine suspended solids to biocarriers and since the biocarriers are much larger than the screen openings, the fine suspended solids will not pass through the screen.

CSO and SSO treatment are major environmental problems. They contain high levels of pathogens and suspended solids that if allowed to discharge untreated into the environment causes significant harm. The EPA prefers that these storm water flows are biologically treated but this is not usually physically or economically feasible. During rain events, the flow of can becomes so high that the WWTP cannot treat the water sufficiently to prevent untreated water from being discharged into the environment. There is not enough time for the bacteria to biologically treat the water and in some cases the flow is so high that the bacteria wash out and are lost.

Dr. Al Sun of CDM discovered an alternative to solve this problem. He showed that if you contact these storm water flows with active biosolids (MLSS) for a short period of time (less than 15 minutes) you will adsorb enough soluble BOD to meet secondary discharge limits achieved by biological treatment rather than the normal 4-12 hours required by traditional methods. In order to accomplish the removal of soluble BOD, both the BioActiflo technology developed by Kruger and the BioMag technology marketed by Siemens require the construction of a separate biological contact tank with a minimum residence time of 15 minutes followed by a separate high rate clarification system (Actiflo or Lamella clarifier). These two requirements take up valuable space that is often not available and involve a high capital investment.

A better solution is to place a high rate clarification or filtering system inside an existing clarifier and to convert the clarifier into a biological contact tank. Since a clarifier normally has a residence time of 2 hours, now as a biological contact tank it only requires a residence time of 15 minutes to remove soluble BOD. This is an eight fold increase in the ability to remove soluble BOD. Also the high rate clarification system placed inside the clarifier prevents the washout of bacteria at high flow rates.

Adding active biosolids to a clarifier can convert the clarifier into a biological contact tank to quickly remove soluble BOD from CSO and SSO. Placing a high rate clarifier or screen separator inside the clarifier will prevent the washout of the active biosolids during high flow conditions. Another enhancement to the performance of a clarifier is to add a biocarrier into the clarifier. This increases the biological treatment capacity of the WWTP and can serve as an anaerobic treatment step in the treatment of nitrogen. As shown FIGS. 8a and 8b a screen separator is placed inside a clarifier. This allows the biosolids in the clarifier to build to a level that the clarifier acts like a biological contact tank to adsorb soluble BOD. Keeping the biosolids active in the clarifier during dry weather and wet weather operations requires that the biosolids receive enough oxygen and food. The concentration of active biosolids in the clarifier can be lowered during dry weather operation and increasing the biosolids concentration during short periods of wet weather operation when it becomes more important to adsorb soluble BOD. A sufficient inventory of active biosolids can be stored in a separate tank or a separate inventory of dried biosolids can be maintained onsite and used during wet weather events. These dried biosolids will become active once wetted and provided with ample food and oxygen. The clarifier that has now been converted into a biological reactor can also include a biocarrier to increases the level of biological treatment taking place in the clarifier. A flocculating polymer can also be added to cause the biosolids to attach to the biocarrier so the biosolids will not pass through the screen openings.

This retrofit requires very little modification to the clarifier except for how the water enters and exits the continuous screen separator mounted inside the clarifier that has been converted to a biological contact tank.

This retrofit can be made to either a primary clarifier or a secondary clarifier, and during normal dry weather, the modified clarifier can be operated normally if the screen separator is bypassed. This operation will reduce the amount of flocculating polymer consumed and lower operating costs.

Biocarriers are most commonly made of thermoplastics because of corrosion resistance, low cost, and lightweight. Polyethylene is the preferred plastic because it is readily available, low cost, and has a specific gravity less than 1.0 g/cc. If a biocarrier plastic has a specific gravity greater than 1.0 g/cc then additional energy has to be expended to keep the biocarrier suspended. If the biocarrier has a specific gravity less than 1.0 it will float and not be effective in treating all the water in the treatment tank. Therefore it is preferable to either entrain air in the biocarrier to make it more buoyant or to add a weighting agent to make the biocarrier less buoyant. Usually virgin plastic is used to manufacture the biocarrier. Preferably virgin polyethylene or polypropylene are used because their density is less than one (1.0 g/cc) and it is not difficult to keep them in suspension with minimum mixing energy. However these virgin plastics are costly and not the best environmental solution. It is preferred to use waste plastics to manufacture the biocarrier. With the use of weighted filler and entrained air or other lightweight filler in the plastic, any thermoplastic waste product is acceptable as long as the plastics used are compatible with each other and will effectively fuse together with the application of heat. Suitable thermoplastics include but are not limited to polyethylene, nylon, polypropylene, polyester, PET, polystyrene, and polyvinyl chloride. This patent claims the melting of these composite waste thermoplastics together with fillers to form biocarriers with varying specific gravities.

Producing a biocarrier from waste plastic is not advisable with the present manufacturing methods. Contaminants in the waste plastic can cause damage to expensive close tolerance extrusion equipment. The shape of the common biocarriers in use today is a hollow cylinder with cross pieces inside the cylinder to increase the surface area of the biocarrier. This shape is easy to achieve in an extrusion process but is not achievable when using waste plastics that can clog the extrusion dies used to form the biocarrier shapes. Therefore, this patent application shows the manufacturing process that can tolerate contaminants in the waste plastic and yet form a biocarrier that has a high surface area.

The method to form the biocarriers is a double roll device. Either the rolls can be heated or the waste thermoplastic composite can be premelted and squeezed into a thin layer between the rolls. As the thin layer of plastic exits the rolls it is either impregnated with an adsorbent material like activated carbon or its surface is processed to increase its surface area. The plastic sheet is then cooled and cut into appropriate sizes.

There are a number of waste products that have little commercial value and therefore are commonly disposed of in landfills. These include but are not limited to expanded polyethylene and polypropylene foams, polystyrene foam, electrical cable covering waste, and carpet waste. Tests have been performed and with the application of heat, a combination of expanded polyethylene foam, carpet waste and weighted filler were fused together into a tough film approximately 1/32 of an inch thick that had close to neutral buoyancy. The fused plastics and weighted fillers formed a tough film that would withstand the environment found in most wastewater treatment applications. The carpet fibers provided added strength to the film and air voids and the use of low-density thermoplastics increased the buoyancy of the biocarrier.

The use of polyethylene and polypropylene plastics are very important because their basic density in their virgin form is less than one and therefore will naturally float. If these plastics are not used to hold together the different components of the biocarrier, then a filler that has a specific gravity of less than one is used to produce a neutrally buoyant biocarrier. Wood products are a good filler material that has a specific gravity less than one. Another source of a waste material to produce a low-cost biocarrier is synthetic waste carpet. Synthetic waste carpet is usually made either of polyethylene, polypropylene (olefin), nylon, or polyester. The respective properties of these plastics are:

| | Melting Temperature (° F.) | Specific Gravity |
|---|---|---|
| Polyethylene | 250 | 0.94 |
| Polypropylene | 320 | 0.90-0.92 |
| Nylon | 400-500 | 1.13-1.15 |
| Polyester | 480 | 1.40 |

Therefore it is important that either polyethylene or polypropylene be used in formulating a biocarrier mixture that has a specific gravity close to one without the addition of air or lightweight filler material to provide the necessary buoyancy.

In order to maintain the integrity of the carpet fibers and their strength, it is important that the temperature to fuse the materials (polyethylene, polypropylene and fillers) in the biocarrier together is lower than the temperature to melt the carpet fibers and this is the case except polypropylene, which melts at the same temperature as olefin fibers which are also polypropylene.

The process selected for producing low cost biocarriers from waste thermoplastics is novel, simple, low cost, and can tolerate contaminants found in waste materials. It is comprised of a mixing system to blend thermoplastics and fillers to the proper consistency, a conveyor system that can heat the thermoplastics to a level that fuses the different components contained in the biocarrier together, rollers that compress the heated thermoplastics to a thin film approximately one sixteenth to one thirty second of an inch in thickness, a cooling system that cools the thermoplastics to a point they can be cut, and a cutting device that cuts the cooled mixture of thermoplastics and fillers into selected lengths and widths to produce a low cost biocarrier.

The conveyor belt is made of material that can withstand the heat necessary to heat the thermoplastics to their melting point and have properties that will prevent the heated thermoplastics from sticking to the belt. A preferred material for the conveyor belt is Teflon. Teflon is slick enough to prevent sticking of the heated thermoplastic, flexible enough to be constructed in the form of a belt, and capable of withstanding heat up to 500° F. with no mechanical degradation.

The roller system is capable of compressing the heated thermoplastics and filler materials into a thin film. This thin film can also be altered by the formation of holes in the film to increase the surface area for bacteria to grow.

The methods for heating the thermoplastics and fillers can either be used to preheat the mixture before it is placed on the conveyor belt or can be applied to the mixture while it is moving on the conveyor belt.

The subject invention, however, in other embodiments, need not achieve all of these objectives and the claims hereof should not be limited only to structures or methods capable of achieving these objectives.

### BRIEF DESCRIPTION OF THE DRAWINGS

Other objects, features and advantages will occur to those skilled in the art from the following description of a preferred embodiment and the accompanying drawings, in which:

FIG. 1a shows the top view details of combining water clarification and sludge dewatering in one self-contained unit.

FIG. 1b shows the side view details of combining water clarification and sludge dewatering in one self-contained unit.

FIG. 2 shows the combination of flocculation and gravity settling in one tank with an enhanced flow path that allows solids to flow freely by gravity from the gravity-settling zone to the flocculation zone.

FIG. 3 shows an anaerobic biological treatment system and a screen separator all contained in one tank.

FIG. 4 shows biological treatment system separated into an aerobic zone and an anaerobic zone combined with a solids separation system (screen separator system) all contained in one tank.

FIG. 5a shows a flocculation system and a screen filtering system all contained in one tank that uses ballast material to improve the performance of a screen separator to remove fine suspended solids from water.

FIG. 5b shows a flocculation system and a screen filtering system all contained in one tank that uses biocarriers to improve the performance of a screen separator to remove fine suspended solids from water.

FIG. 6 shows a clarifier modified by the addition of a screen separator in the overflow from the clarifier.

FIG. 7a shows the side view of a two-stage screen separator and flocculator contained in one unit that removes grit, floatables, and fine suspended solids with the aid of ballast material.

FIG. 7b shows the top view of a two-stage screen separator and flocculator contained in one unit that removes grit, floatables, and fine suspended solids with the aid of ballast material.

FIG. 8a shows the top view of a screen separator installed in a gravity clarifier that has been converted into a biological treatment tank.

FIG. 8b shows the side view of a screen separator installed in a gravity clarifier that has been converted into a biological treatment tank.

FIG. 9 shows a method for manufacturing biocarriers from waste thermoplastics.

FIG. 10 shows the shape of a biocarrier manufactured from waste thermoplastics.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

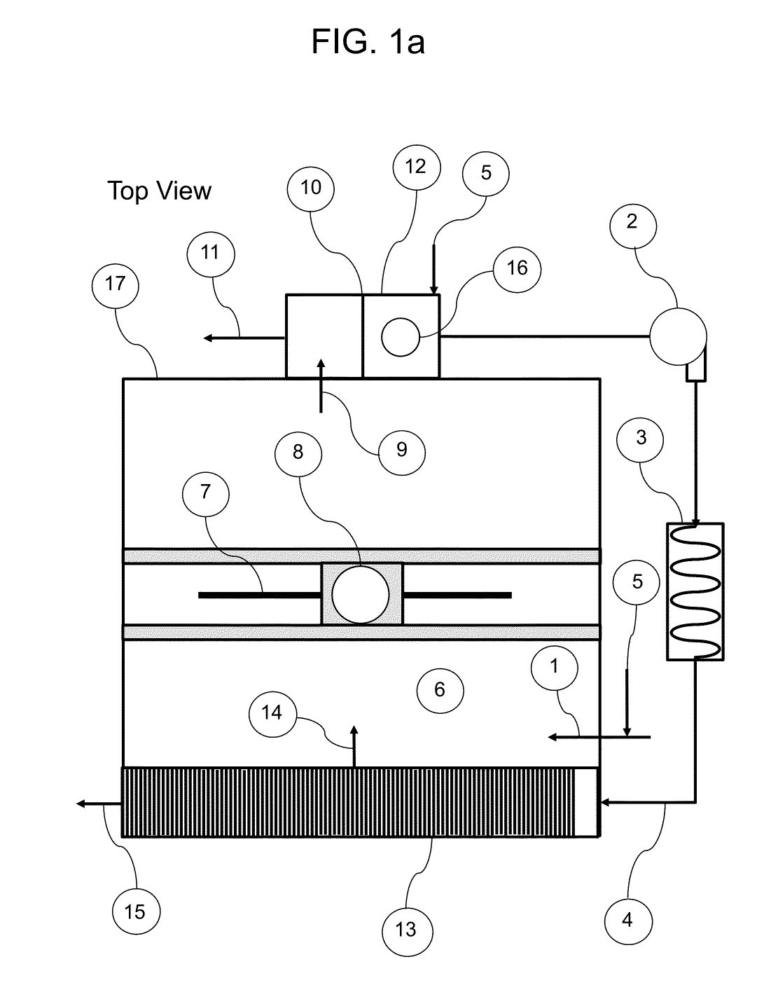

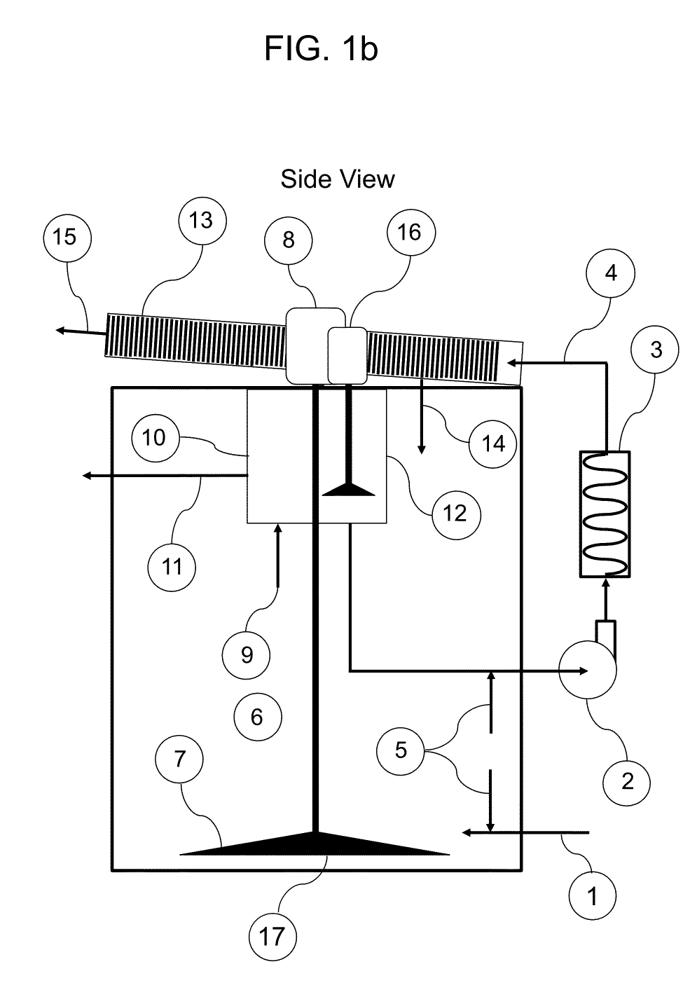

FIG. 1a shows the top view of a combination high rate clarification system and a dewatering system all contained in one tank (17). Unclarified water (1) flows into the clarification/dewatering system (17) and with the addition of a flocculating polymer (5) the suspended solids in the unclarified water (1) are caused to flocculate together in a flocculation area (6) with the aid of a mixer (8) and flocculating mixer blade (7). The flocculated water flows (9) into a separation device (10) that separates the floc into a pretreatment tank (12) equipped with a flocculation mixer (16) and clarified water that exists the separation device (10) through a pipeline (11). Flocculating polymer (5) is added to the pretreatment tank (12) so that the waste solids can be effectively flocculated prior to dewatering. A low shear pump (2) transfers the flocculated waste solids from the pretreatment tank (12) through an optional inline static mixer (3) for further flocculation. The flocculated waste solids flow through a pipeline (4) into a dewatering device (13). Filtrate from the dewatering device (13) flows (14) back into the flocculation area (6) to be clarified and dry filter cake (15) of waste solids is discharged from the dewatering device (13) for disposal.

For clarity, FIG. 1b shows the side view of a combination high rate clarification and dewatering system (17) shown in FIG. 1a.

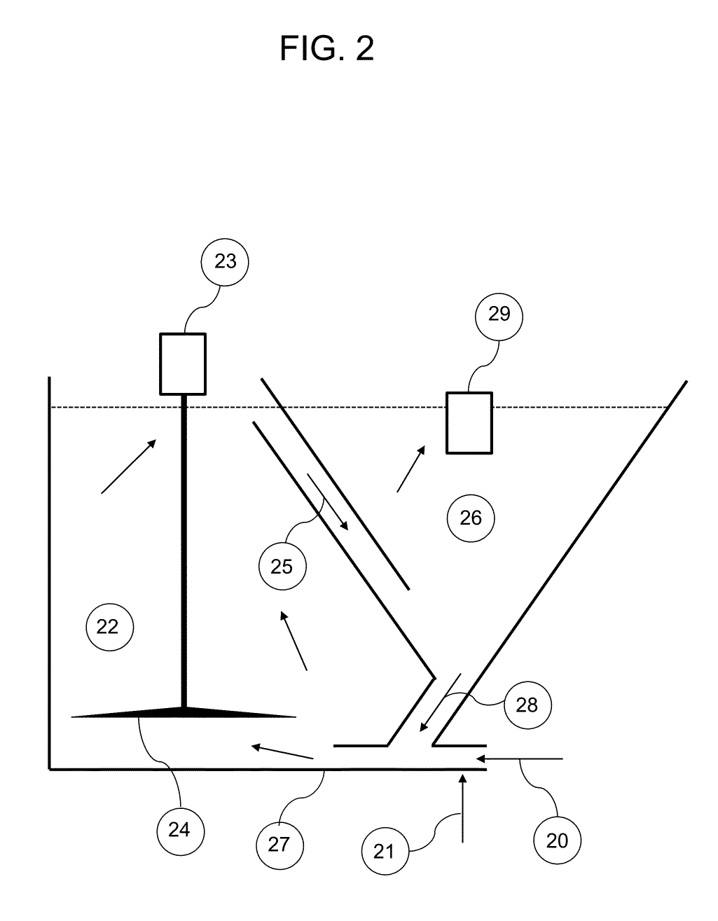

FIG. 2 shows a combined flocculation chamber (22) and gravity-settling chamber (26) in one treatment tank (27). In this patent application, the flow path of water through the treatment tank (27) has been routed to allow for high flow rates and to allow the unhindered flow by gravity of settled solids from the gravity settling chamber (26) of the treatment tank (27) into the flocculation chamber (22) of the treatment tank (27). Unclarified water enters through a pipeline (20) into the flocculation chamber (22) that is equipped with a mixer (23) and a floc mixer blade (24) to provide enough agitation to flocculate the solids contained in the incoming unclarified water (20) with settled solids (28) with the aid of a flocculating polymer (21). The flocculated solids exit the flocculation chamber (22) and then flow through a passageway (25) into the gravity settling chamber (26). Clarified water flows to the top of the gravity settling chamber (26) and exits the treatment tank (27) through a discharge trough (29). Settled solids (28) exit out the bottom of the gravity settling chamber (26) and become entrained with the incoming unclarified water (20) and flocculating polymer (21).

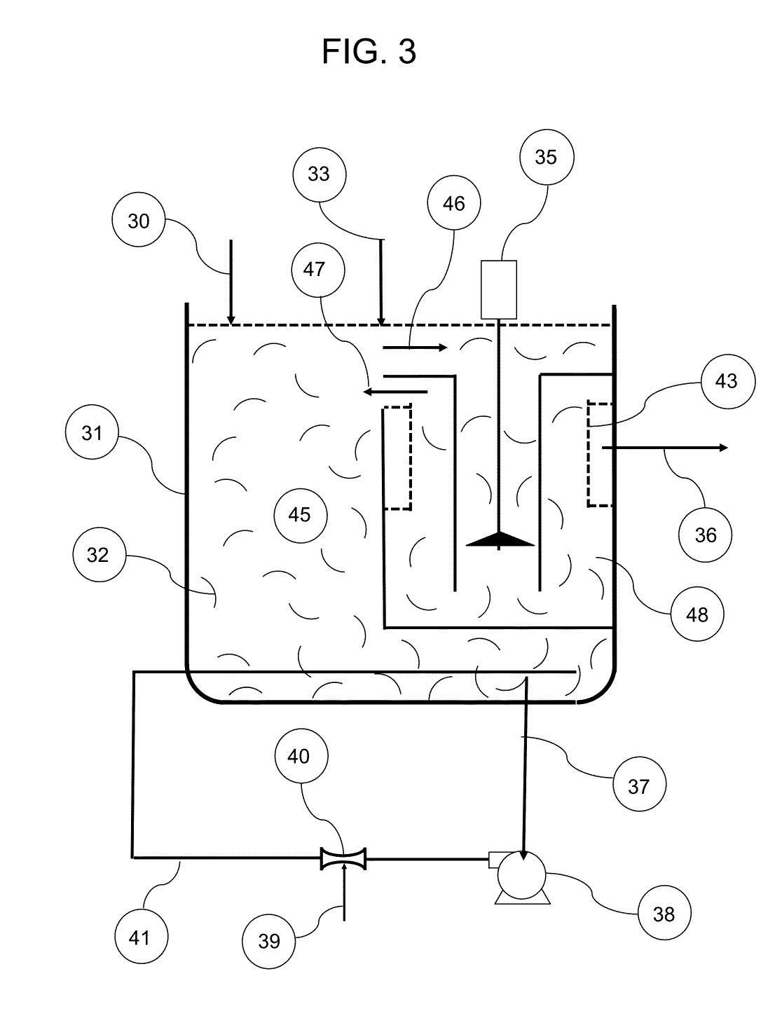

FIG. 3 shows the details of screen flocculator device (48) mounted inside a biological or chemical reactor (31). Water (30) to be treated flows into the biological reactor (31) into a nitrification zone (45) where there is a sufficient level of oxygen to support the biological treatment process because of oxygenated water injected through pipeline (41). This nitrification zone (45) contains aerobic biocarriers (32) that have neutral buoyancy with a density near 1.0 g/cc and therefore remain in suspension with a minimum amount of mixing turbulence. Aerobic biocarrier (32), mobile bacteria, and suspended solids all flow (46) into a screen flocculator (48) that is composed of a flocculation mixer (35) that causes with the addition of a flocculating polymer (33) the bacteria and suspended solids to attach to the aerobic biocarrier. The aerobic biocarriers (32) and the attachments of suspended solids thereto are hence too large to pass through the screen separator (43) and therefore flow back into the biological reactor (31) through a passageway (47). Clarified water passes through the screen separator (43) and exits the biological reactor (31) through a pipeline (36). Water contained in the biological reactor (31) is pumped (38) through a pipeline (37) and into a Venturi aeration device (40) that inducts air (39) into the water flowing though pipeline (41) back into the biological reactor (31).

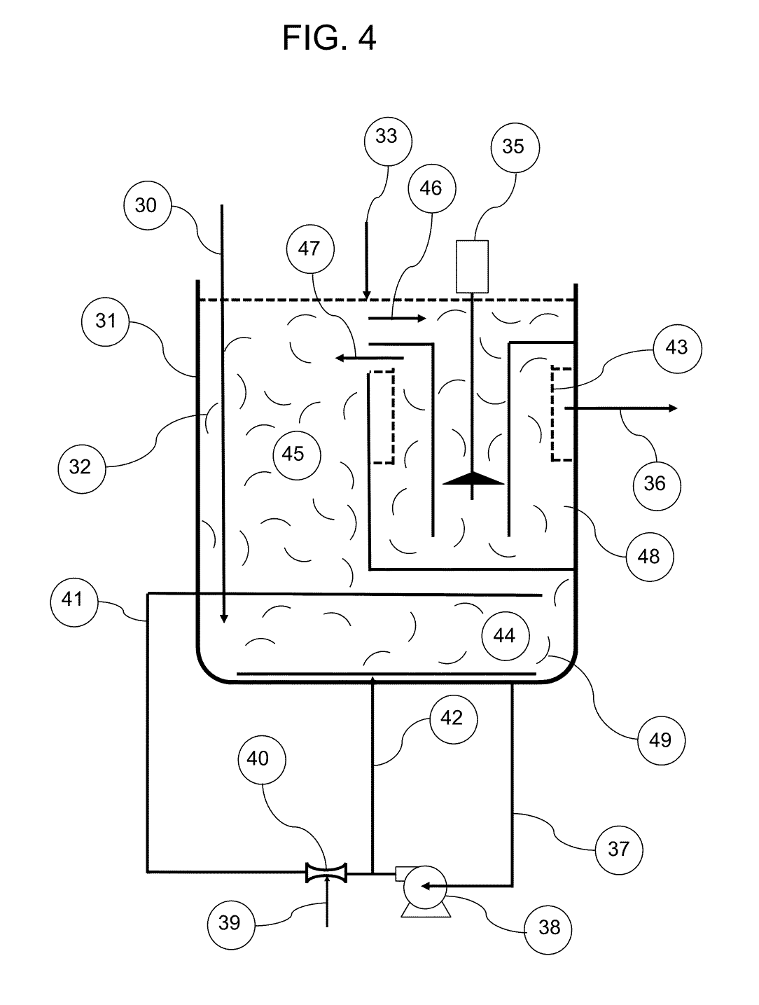

FIG. 4 is similar to FIG. 3 with the exception that the biological reactor (31) contains two zones; an anaerobic zone (44) where bacteria convert nitrogen compounds such as nitrates and nitrites into nitrogen gas (nitrification) and an aerobic zone (45) where bacteria convert nitrogen compounds such as ammonia into nitrates and nitrites (denitrification). In FIG. 4, water (30) to be treated flows into the biological reactor (31) and first enters the denitrification zone (44) where there is a lack of oxygen and which contains anaerobic biocarriers (49) that are heavier than water so they remain in the denitrification zone (44). Water then flows up to the nitrification zone (45) where there is an ample level of oxygen because of oxygenated water injected through pipeline (41). This nitrification zone (45) contains aerobic biocarriers (32) and because they are more buoyant with a density less than 1.0 g/cc, they remain in the nitrification zone (45). Water from the denitrification zone (44) flows through pipeline (37) and is pumped (38) through a Venturi device (40) that entrains air (39) into a pipeline (41) and flows back into the nitrification zone (45) of the biological reactor (31) to oxygenate the bacteria and to keep the nitrification biocarrier (32) in suspension. Unaerated water from the denitrification zone (44) flows through pipeline (42) to provide circulation for the denitrification biocarriers (43) residing therein. The nitrification biocarriers (32) and denitrification biocarriers (49) will naturally segregate because of their different densities so they will remain in their respective aerobic (45) and anaerobic (44) zones. The density of these biocarriers can be adjusted by the proper ratios of weighted fillers, buoyant fillers, and proper thermoplastics preferably waste thermoplastics. Aerobic biocarrier (32), mobile bacteria, and suspended solids all flow (46) into a screen flocculator (48) that is composed of a flocculation mixer (35) that causes with the addition of a flocculating polymer (33) the bacteria and suspended solids to attach to the aerobic biocarrier and screens (43). The aerobic biocarrier (32) and the attachments of suspended solids thereto are therefore too large to pass through the screens (43) in the screen flocculator (48) and therefore flow back into the biological reactor (31) through a passageway (47) back into the aerobic zone (45). Clarified water passes through the screen (43) and exits the biological reactor (31) through a pipeline (36).

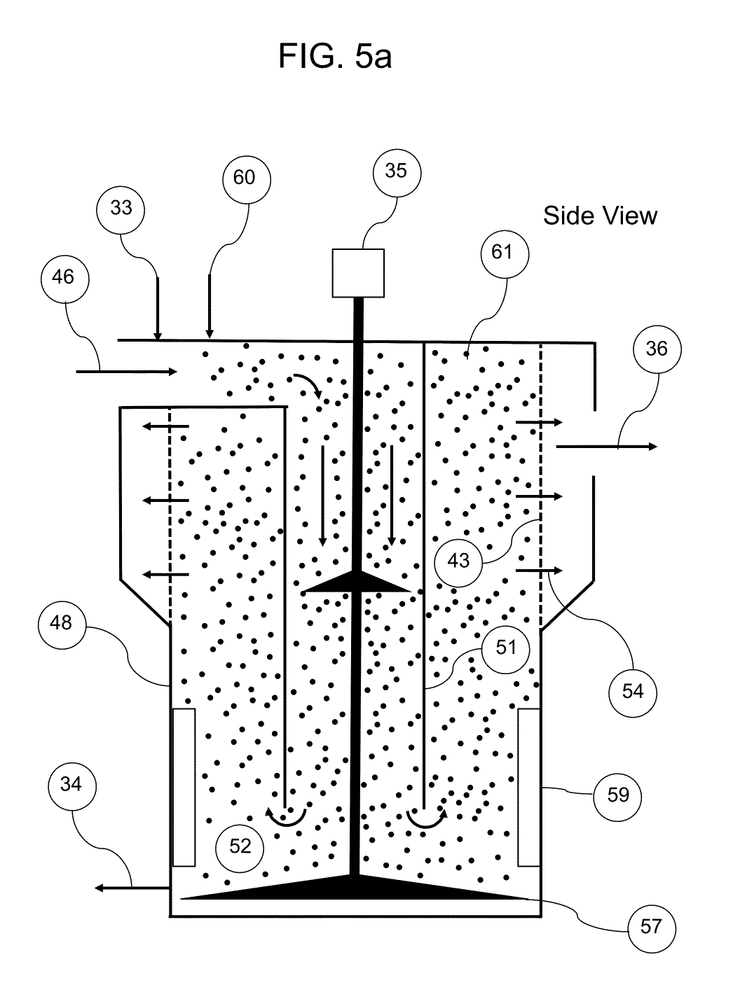

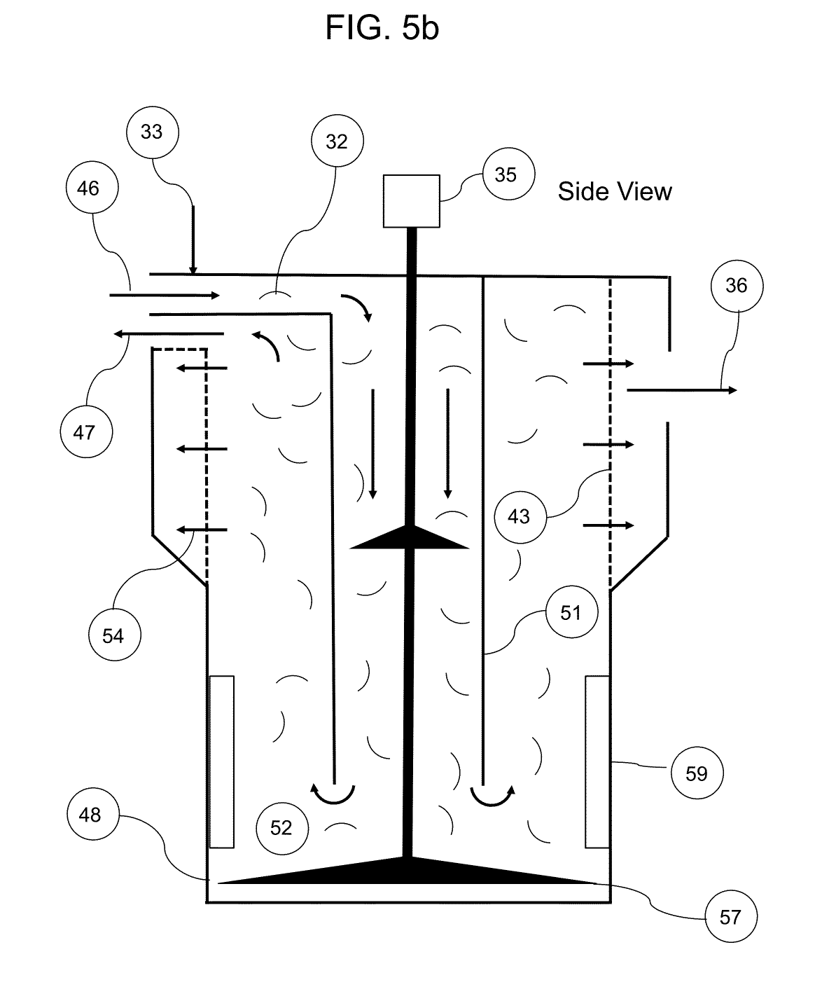

FIG. 5a shows a more detailed side view of the screen flocculator (48) shown in FIGS. 3 and 4. Mobile bacteria and suspended solids all flow (46) into a screen flocculator (48) and with the addition of flocculating polymer (33) and clean ballast (60) a ballasted floc is formed in the down draft tube (51) and continues in a flocculation zone (52) with the aid of a flocculation mixer blade (57) and vortex breaking baffles (59). The fine suspended solids attached to the ballast (61) and will not pass through the screens (43) because of the large size of the ballast but clarified water (54) will pass through the screens (43) and exit the screen flocculator (48) through a pipeline (36). Ballast that does not pass through the screen (43) exits the screen flocculator (48) through a pipeline (34) for cleaning and reuse.

FIG. 5b shows an alternative to FIG. 5a where a biocarrier is used in place of ballast to improve screen performance. Biocarrier (61), mobile bacteria, and suspended solids all flow (46) into a screen flocculator (48) that is composed of a screen (43) and a flocculation mixer (35) that causes with the addition of a flocculating polymer (33) the bacteria and suspended solids to attach to the biocarrier (61). This flocculation starts in the down draft tube (51) and continues in a flocculation zone (52) with the aid of a flocculation mixer blade (57) and vortex breaking baffles (59). The fine suspended solids attached to the biocarrier (61) will not pass through the screens (43) because of their large size but clarified water (54) will pass through the screens (43) and exit the screen flocculator (48) through a pipeline (36). Biocarrier that does not pass through the screen (43) exits the screen flocculator (48) through a passageway (47) and back into the biological reactor.

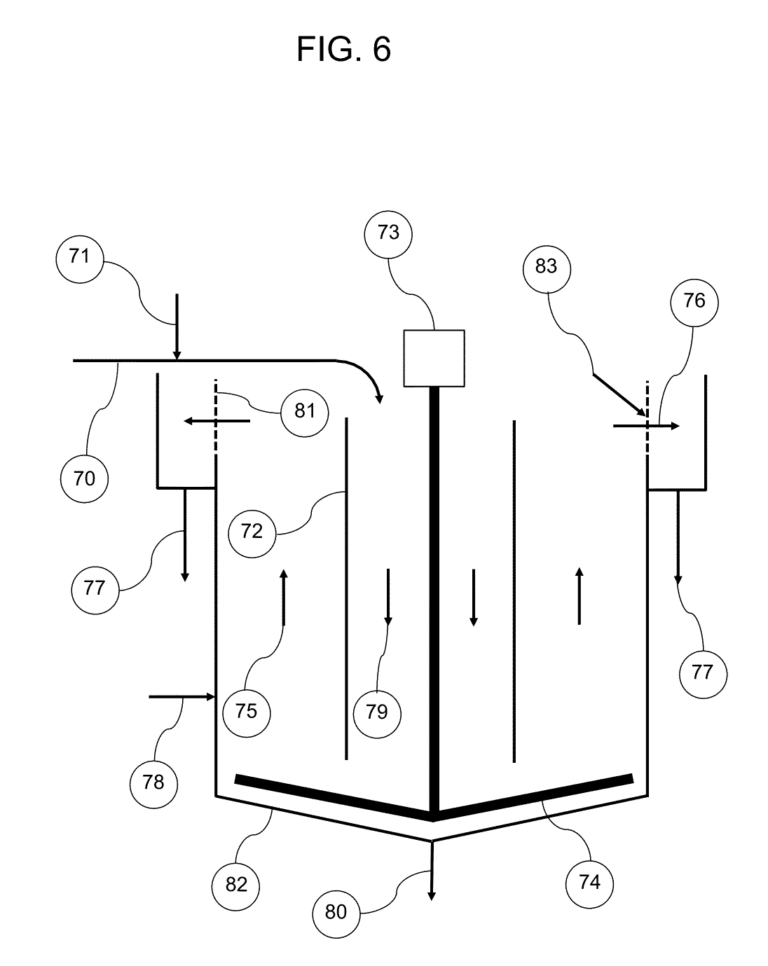

FIG. 6 shows retrofitting a gravity clarifier (82) with screens (81) and a screen cleaning system (83). Water flowing through a pipeline (70) is combined with a flocculating polymer (71) and flows downward (79) through a vertically positioned tube (72) to enhance flocculation. Air and water may be injected (78) into the gravity clarifier (82) to keep solids in suspension and to cause a circular flow of the water in an upward direction (75) to prevent the buildup of flocculated solids on the screens (81) and to allow filtered water (76) to flow through the screens (81) to be discharged through a pipeline (77). As the level of solids builds up in the gravity clarifier (82), solids move to the center of the gravity clarifier (82) assisted by the movement of a rake (74) powered by a motor (73) and the excess solids are discharged through pipeline (80). While not shown, ballast can be added to the incoming water (70) to form a weighted floc that will settle rapidly in the gravity clarifier (82). Weighted floc can then be withdrawn through pipeline (80), cleaned, and returned for reuse. Another option not shown is the addition of biocarrier to enhance the biological treatment capability of the gravity clarifier (82).

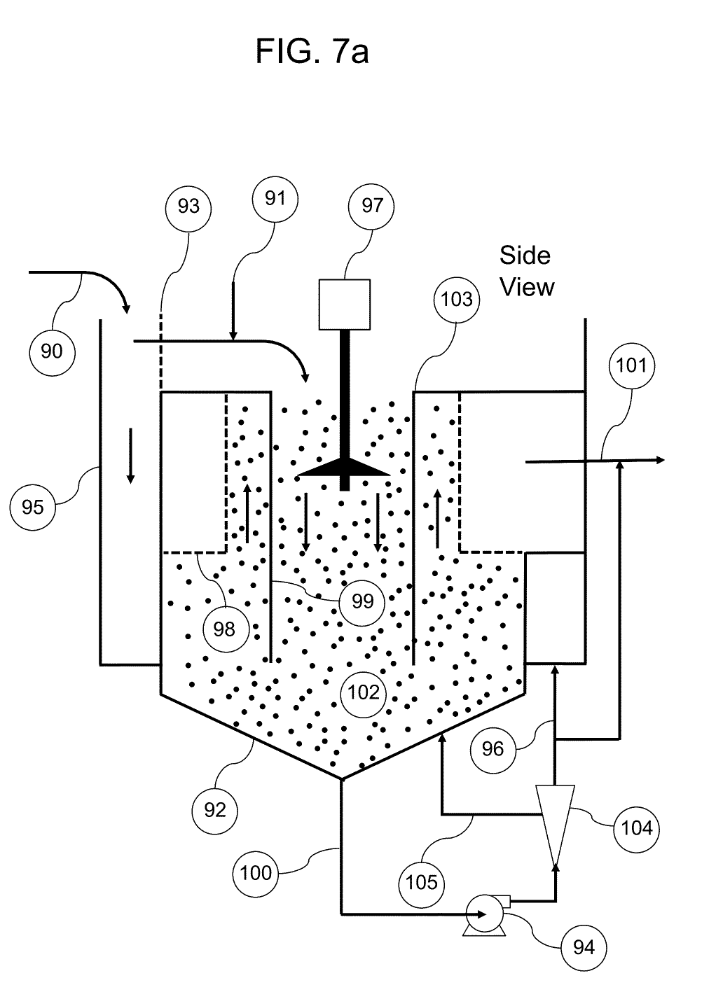

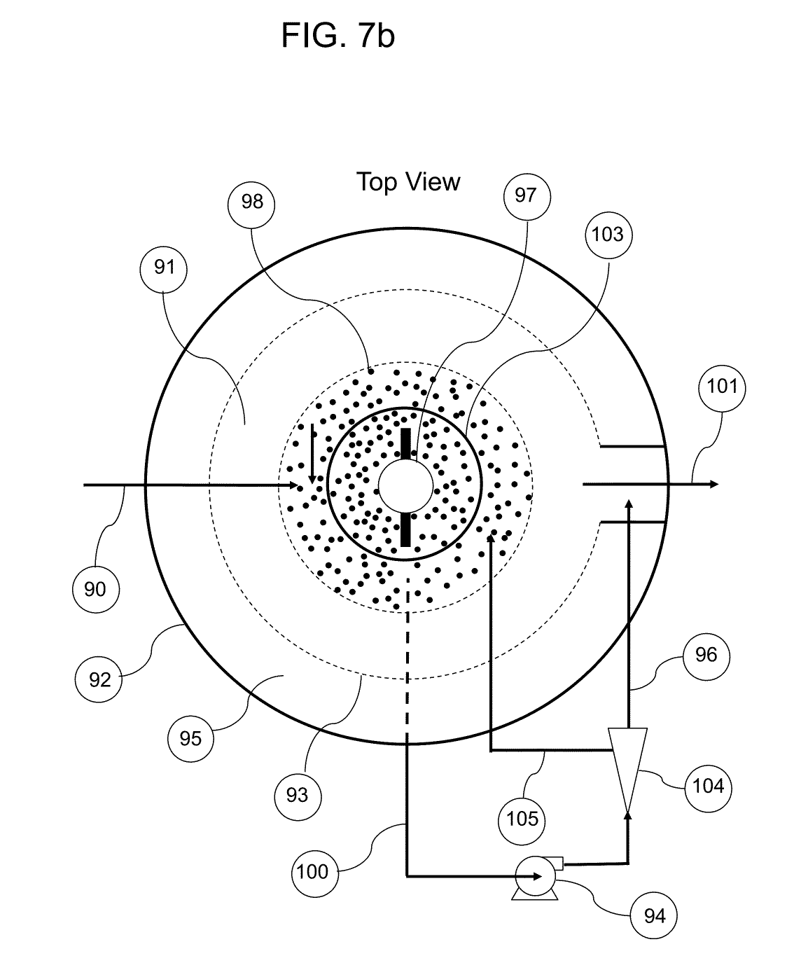

FIG. 7a shows the side view of a two-stage screen flocculator (92) that combines grit and floatables separation in a first stage and flocculation in a second stage to remove fine suspended solids with the use of a polymer and a ballast material. Water containing floatables, settleable solids such as grit, and fine suspended solids flow through a pipeline (90) and into the two-stage screen flocculator (92). Solids such as grit and floatables that cannot pass through a screen (93) are deposited into a collection chamber (95) and solids that pass through the screen (93) such as fine sediments and colloidal sized particles flow downward through a center tube (99) and with the aid of a mixer (97) and a flocculating polymer (91) combine to form a weighted floc with the ballast material contained in the flocculation zone (102). The weighted floc flows upward until it reaches another finer screen (98) that allows clarified water to pass into a discharge pipeline (101) and rejects any solids greater than the screen (98) size opening. Since the fine solids have flocculated with ballast material that is larger in size than the screen (98) openings, no solids leave the system. This causes fine solids to build up in the flocculation zone (102) to the point that excess solids flow out through a pipeline (100) and are pumped (94) into a separation device (104) that separates large size ballast material, which flows through pipeline (105) back into the flocculation zone (102) of the two-stage screen flocculator (92). Fine solids that are separated by the separation device (104) flow through a pipeline (96) and into the collection chamber (95) or discharged directly into the discharge flow (101) after the storm event is over and flow through the two-stage screen flocculator (92) is reduced.

FIG. 7b shows added top view details of the two-stage screen flocculator (92) shown in FIG. 7a that combines grit and floatables separation in a first stage and separation of flocculated fine suspended solids with the use of a polymer and a ballast material in a second stage.

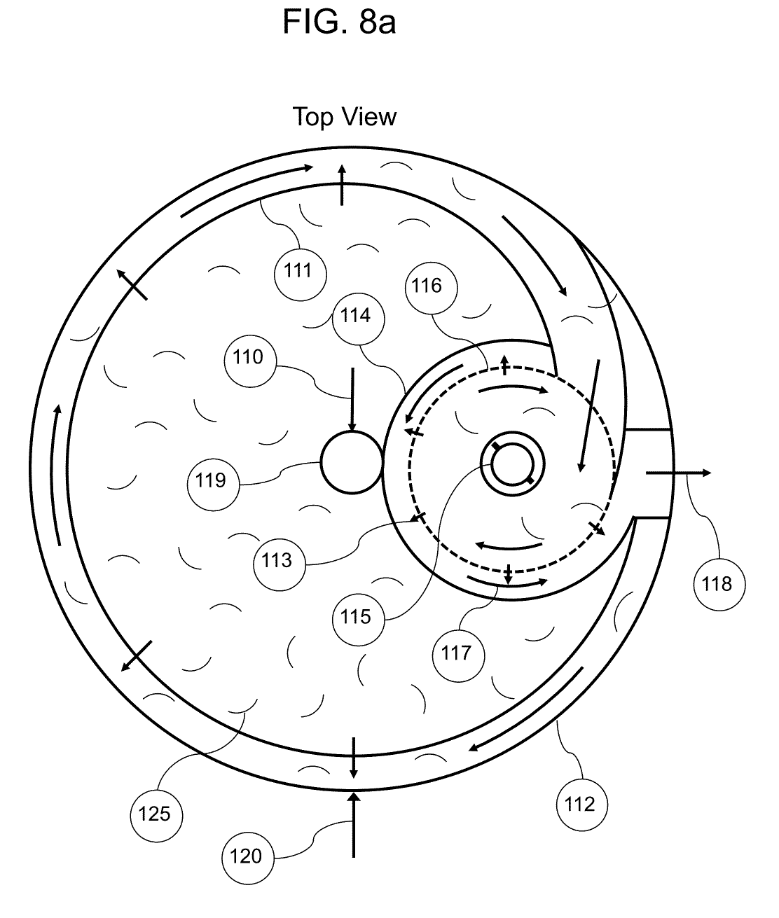

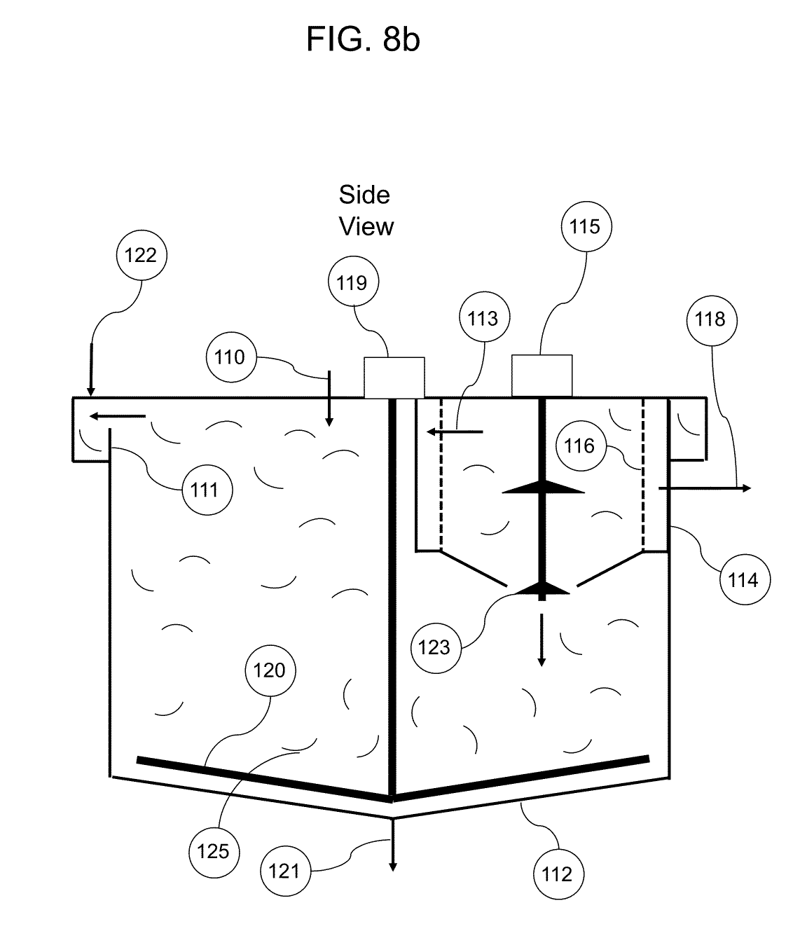

FIG. 8a shows the top view of a gravity clarifier (112) converted to a biological reactor by the addition of a biocarrier (125). Water containing suspended solids (110) flows into the gravity clarifier (112) that contains biocarrier (125) and both rise in the clarifier until they flow over a weir (111) into a trough (124) located along the perimeter of the gravity clarifier (112). Flocculating polymer (120) is added to the trough (124), which causes flocculation of the suspended solids with the biocarrier to occur before they reach the screen flocculator (114). The screen flocculator (114) contains screens (116) that prevent the flocculated solids from leaving the gravity clarifier (112). The flocculated solids attached to the biocarrier (125) enter into the screen flocculator (114) and rotate in a clockwise direction, which keeps the screens (116) clean. Clarified water (113) passes through the screens (116) and flows in a counter clockwise direction until it discharges (118) from the gravity clarifier (112). Located inside the screen flocculator (114) is a mixer (115) that keeps the flow of water moving in a clockwise direction and causes the flocculated solids that contain the biocarrier (125) to discharge out the bottom of the screen flocculator (114) and back into the gravity clarifier (112). Air and water (126) are added to the clarifier to keep the bacteria and biocarrier (125) mixed and oxygenated.

FIG. 8b shows for added detail the side view of a gravity clarifier (112) in FIG. 8a that has been retrofitted with a screen flocculator (114) equipped with a motor (115) to move the solids out of the screen flocculator (114) and back into the gravity clarifier (112). A mixer blade (123) causes the flow in the screen flocculator (114) to exit out the bottom and back into the gravity clarifier (112). A mixer motor (119) causes a scraper blade (120) to rotate and discharge settled solids out a pipeline (121).

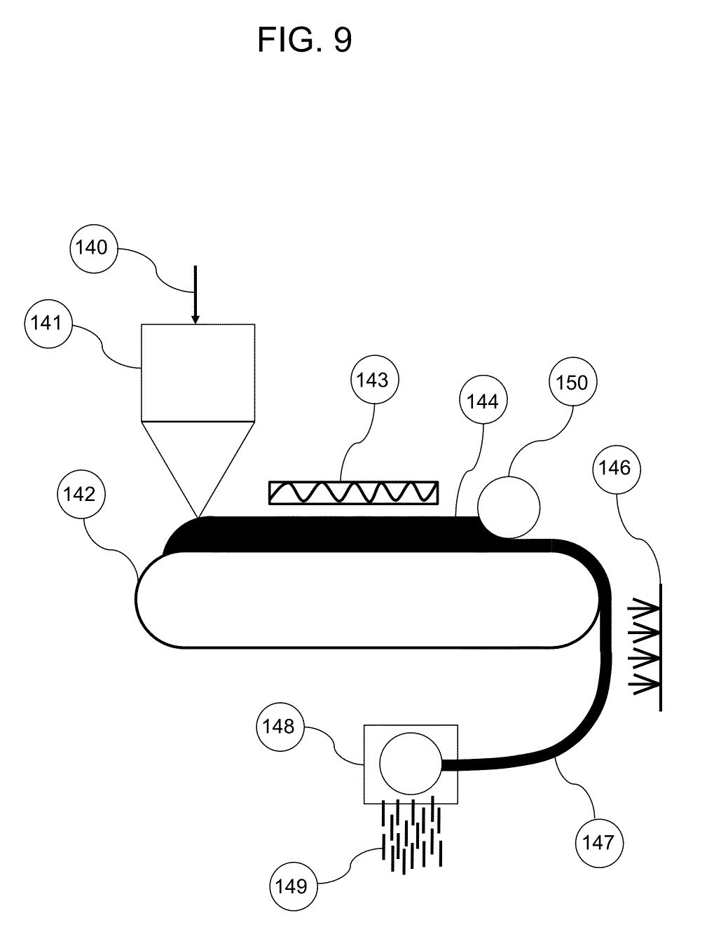

FIG. 9 shows a device for producing a low cost biocarrier produced from waste thermoplastic material and filler material. Waste thermoplastic and filler (140) are loaded into a hopper (141) that homogenizes the material, which is then deposited onto a conveyor (142). The mixture of plastic and filler material is either heated in the hopper (141) or heated on the conveyor (142) with a heater (143) that raises temperature of the mixture to a point that all the components of the mixture (144) fuse together. A roller (150) compresses the heated mixture on the conveyor (142) to the desired thickness and shape. The formed mixture then discharges off the conveyor (142) and is cooled by a water spray (146) or other cooling device. The cooled mixture (147) then passes into a cutter device (148) that cuts the mixture into the appropriate size and shape to form a biocarrier (149).

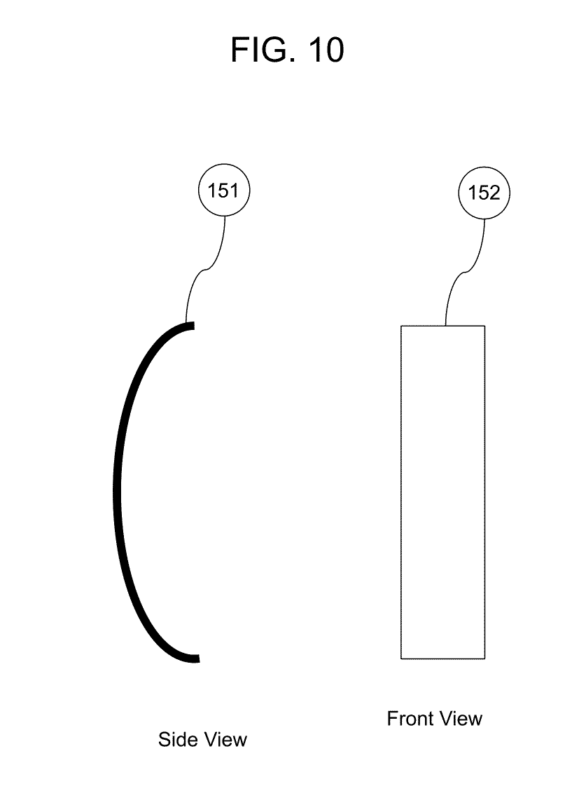

FIG. 10 shows the shape of a biocarrier produced from waste thermoplastic and a composite of filler materials to change the density of the biocarrier and its buoyancy. The side view (151) shows the curved nature of the biocarrier to enhance its ability to move in the water, and the front view (152) shows another view of the biocarrier's shape.

The invention claimed is:

1. A process that treats water by combining a clarification system that removes suspended solids from water and a dewatering system that removes water from a slurry to produce a solid cake in one combined unit.

2. The clarification system of claim 1 includes any separation system that removes solids from liquids to produce a concentrated slurry waste stream and includes but is not limited to ballast clarification using any magnetic material or any ballast material heavier than water, gravity clarification, or any membrane clarification method.

3. The magnetic material of claim 2 is any material that is attracted to a magnet.

4. The magnetic material of claim 3 is preferably but not limited to magnetite and zero valent iron.

5. A process in claim 1 where the dewatering system is mounted on top of the clarification system so that filtrate from the dewatering system flows by gravity into the clarification system for further treatment and clarification.

6. The dewatering system of claim 1 is any system that reduces the water content of a slurry to produce a solid cake of reduced moisture content and such dewatering system includes but is not limited to belt presses, fan presses, ring presses, filter presses, centrifuges, and screw presses.

7. The moisture content of the solid cake of claim 6 ranges from 15% to 50% and preferably the solid cake will pass the paint filter drip test.

8. The dewatering system of claim 1 is mounted either in a horizontal, vertical, or inclined position.

9. The discharge from the dewatering system of claim 1 overhangs the clarification system so that the discharged solid cake can flow into a hopper or can be moved to another location by either an auger or conveyor belt.

10. A process that combines biological treatment and a screen separator in one tank.

11. A screen separator in claim 10 that includes preferably a deflective screen that prevents the discharge of solid material.

12. The biological treatment of claim 10 includes any biological treatment method that uses biocarriers.

13. The biological treatment of claim 10 includes any process that is aerobic or anaerobic in nature.

14. The biocarriers of claim 12 are made of waste materials including any waste material of organic nature that has a specific gravity between 0.8 to 1.5.

15. The waste materials of claim 14 are preferably any waste plastics or waste nonwoven cloth materials like baby wipes or other similar materials.

16. The biological treatment of claim 10 uses flocculating polymers to attach fine suspended solids to biocarriers or ballast material to prevent the passage of fine suspended solids through the screen separator.

17. The screen separator of claim 10 is mounted inside the biological treatment tank or any treatment tank where flocculation occurs

18. A process that places a high rate clarification system inside a biological contact tank.

19. The high rate clarification system of claim 23 is preferably but not limited to a magnetic ballast clarification system.

20. The biological contact tank of claim 23 contains active biosolids that are capable of adsorbing dissolved BOD material.
